(19) United States
(12) Patent Application Publication
(10) Pub. No.: US 2005/0012383 A1
(43) Pub. Date: Jan. 20, 2005

(54) Wheel rim cover engagement device

(76) Inventor: Yung-Ting Hsieh, Yung Kang City (KR)

Correspondence Address: ROSENBERG, KLEIN & LEE, 3458 ELLICOTT CENTER DRIVE-SUITE 101, ELLICOTT CITY, MD, 21043, US

(21) Appl. No.: 10/618,660

(22) Filed: Jul. 15, 2003

(51) Int. Cl. B60B 7/00

(52) U.S. Cl. 301/37.102

(57) ABSTRACT

A wheel rim cover engagement device includes an engage ring and a steel ring. The engage ring is fixed in the recess of the flange of a wheel rim, and a wheel rim cover has its inner fastening members tightly clasp the engage ring and is fixedly assembled on the wheel rim, able to solve the problem that a wheel rim cover cannot directly be installed on the wheel rim of a large-size car because the radian of the flange of the wheel rim is too large and the inner circumferential edge of the wheel rim is too straight.

### BACKGROUND OF THE INVENTION

1. Field of the Invention

This invention relates to a wheel rim cover engagement device, particularly to one for assembling a wheel rim cover on the wheel rim of a large-size car. The wheel rim cover engagement device is provided with an engage ring having a plurality of resilient engage members. The engage ring is engaged in the recess of the flange of the wheel rim of a car, and a steel ring is forcefully fitted in the annular accommodating groove of the engage ring to force the resilient engage members of the engage ring to push against the inner wall of the flange of the wheel rim. A wheel rim cover is assembled on the engage ring, which is engaged on the inner edge of the wheel rim, by bolts or by the hooking portions of the fastening members of the wheel rim cover, able to solve the problem that a wheel rim cover cannot directly be installed on the wheel rim of a large-size car because the radian of the flange of the wheel rim is too large and the inner circumferential edge of the wheel rim is too straight.

2. Description of the Prior Art

Generally, a driver not only cares the maintenance of his car but also pays much attention to enhancement of the aesthetic appearance of his car. For the present, most common cars have the wheel rims covered with wheel rim covers so as to achieve effective embellishment. A conventional wheel rim cover has its circumferential edge formed with a plurality of fixing bases respectively for receiving engage members thereon. Each engage member has a hooking portion for firmly clasping the flange of the wheel rim when the wheel rim cover is installed on the wheel rim. Another kind of conventional wheel rim cover is provided with plural engage members protruding upward on the circumferential edge and each engage member is formed with a recess in the inner side for fitting a steel ring therein to let the engage members have a proper resilience and an outward push force. Thus, when a wheel rim cover is installed on a wheel rim, the resilient engage members can have their combining portions urged firmly in the recessed and arc-shaped inner edge of the wheel rim, thus stably assembling the wheel rim cover on the wheel rim.

Nevertheless, the wheel rim cover engagement devices mentioned above are only applicable to the wheel rim of common cars. For the present, it is still hard to assemble a wheel rim cover on the wheel rim of a large-size car, such as a bus, a freight car, a truck and the like. Because the flange of the wheel rim of a large-size car is formed with a comparatively large and long radian; therefore, a wheel rim cover with engage members is unable to have the hooking portions of its engage members clasp the flange of the wheel rim of a large-size car. Besides, the inner circumferential edge of the wheel rim of a large-size car is smooth and somewhat straight without any arcuate recess; therefore a wheel rim cover with protruding-up engage members is unable to have the projecting combining portions of its engage members engaged firmly with the wheel rim.

To solve such a problem, an engagement device for assembling a wheel rim cover on the wheel rim of a large-size car was designed. The engagement device, as shown in FIGS. 10 and 11, is provided with a steel ring 71 having plural locking blocks 72 to be fixed in the recess of the flange 31 of a wheel rim. The steel ring 71 has its opposite ends respectively formed with a left and a right threaded portion 711, 712 respectively screwed with the left and the right threaded hole 731, 732 of an adjusting member 73. The adjusting member 73 can be turned around by a hand tool inserting in its insert hole 733 to expand outward the steel ring 71 and simultaneously fix the locking block 72 in the recess of the flange 31 of the wheel rim 3.

Each locking block 72 is formed with an arc-shaped portion 721 to be fitted in the recess of the flange 31 of the wheel rim 3 and a round hole 722 in the center. Thus, a screw 74 can be inserted through the insert hole 75 of a wheel rim cover 7 and screwed in the round hole 722 of the locking block 72 to fix the wheel rim cover 7 on the wheel rim 3.

However, the conventional wheel rim cover engagement device described above has the following drawbacks.

1. In assembling, the locking blocks must have their round holes respectively aligned to the insert holes of the wheel rim cover so as to enable a bolt to be accurately screwed therethrough, taking too much time in assembling.

2. The adjusting member and the threaded portions of the opposite ends of the steel ring are together turned around to make the steel ring expand outward, therefore the adjusting member must be column-shaped and bored with an insert hole so as to allow the adjusting member to be rotated smoothly in the recess of the flange of the wheel rim, and besides a special tool has to be employed to turn around the adjusting member, inconvenient in assembling.

3. The wheel rim cover has to be bored with insert holes for screws to pass therethrough and be screwed with the locking blocks, thus spoiling the integral aesthetic appearance of the wheel rim cover.

### SUMMARY OF THE INVENTION

The objective of the invention is to offer a wheel rim cover engagement device which is provided with an engage ring having a plurality of resilient engage members fitted with a steel ring. The engage ring together with the steel ring is installed in the recess of the flange of a wheel rim, so that a wheel rim cover can be secured on the engage ring by means of its fastening members, able to solve the problem that a wheel rim cover cannot be assembled thereon because of the wheel rim flange of a large-size car having an excessive radian and the inner edge of the wheel rim being too straight, Besides, it is not necessary to adjust the position of the locking members to align with the insert holes of the wheel rim cover as the conventional wheel rim cover engagement device does, able to assemble a wheel rim cover on a wheel rim with quickness.

### BRIEF DESCRIPTION OF DRAWINGS

The present invention will be better understood by referring to the accompanying drawings, wherein:

FIG. 1 is an exploded perspective view of a first embodiment of a wheel rim cover engagement device in the present invention:

FIG. 2 is a side cross-sectional view of the first embodiment of the wheel rim cover engagement device in the present invention:

FIG. 3 is a cross-sectional view of the first embodiment of the wheel rim cover engagement device in the present invention:

FIG. 4 is a cross-sectional view of a second embodiment of the wheel rim cover engagement device in an operating condition in the present invention:

FIG. 5 is a cross-sectional view of the second embodiment of the wheel rim cover engagement device in another operating condition in the present invention:

FIG. 6 is an exploded perspective view of a third embodiment of the wheel rim cover engagement device in the present invention:

FIG. 7 is a cross-sectional view of the third embodiment of the wheel rim cover engagement device in an assembled condition in the present invention:

FIG. 8 is a cross-sectional view of the third embodiment of the wheel rim cover engagement device in another assembled condition in the present invention:

FIG. 9 is a cross-sectional view of a fourth embodiment of the wheel rim cover engagement device in the present invention:

FIG. 10 is an exploded perspective view of a conventional wheel rim cover engagement device: and

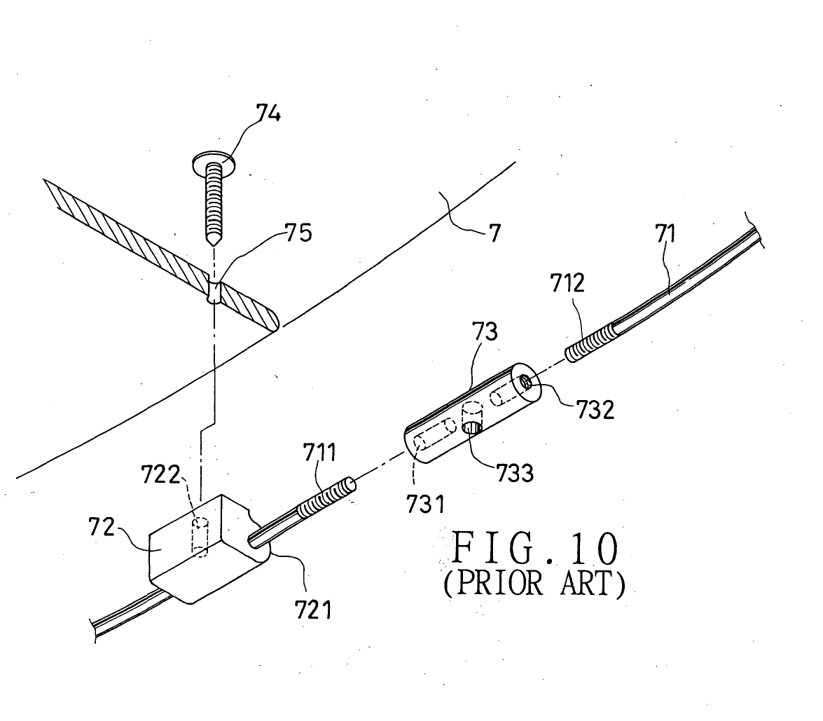

FIG. 11 is a cross-sectional view of the conventional wheel rim cover engagement device.

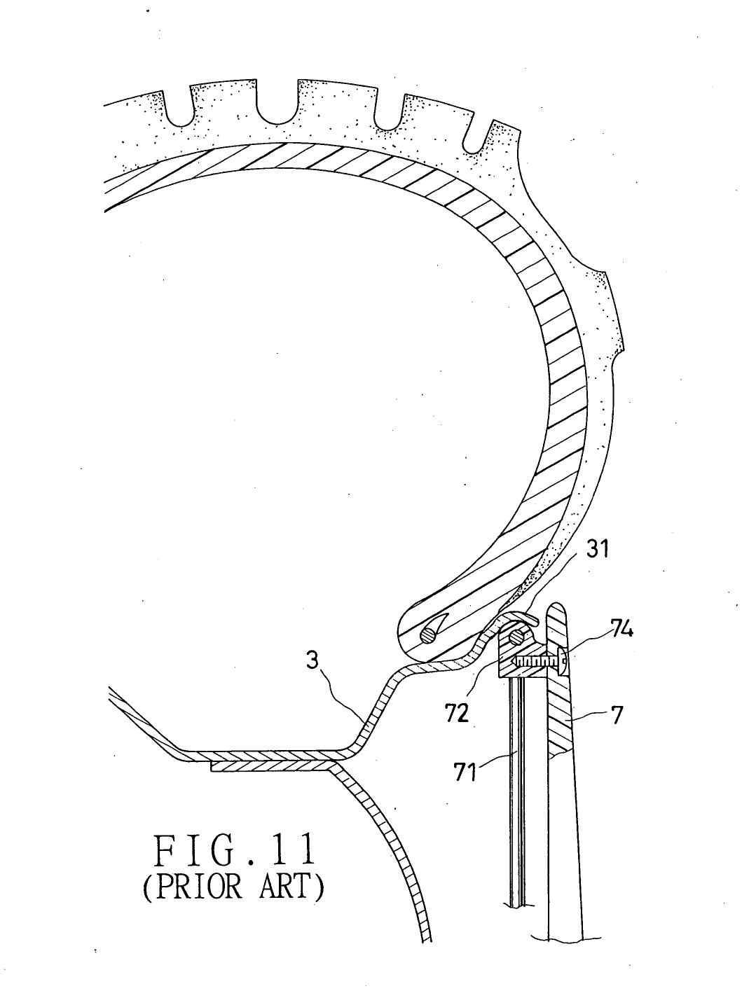

### DETAILED DESCRIPTION OF THE PREFERRED EMBODIMENT

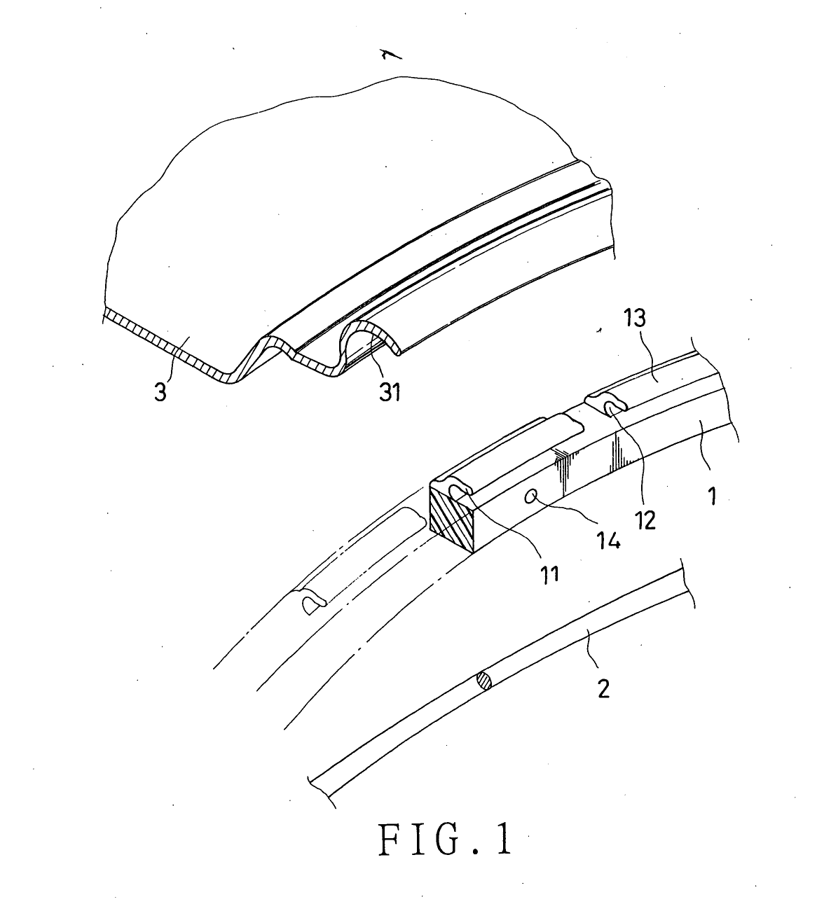

A first preferred embodiment of a wheel rim cover engagement device in the present invention, as shown in FIG. 1, includes an engage ring 1 and a steel ring 2 combined together.

The engage ring 1 made of plastic has its outer circumferential edge formed with a plurality of resilient engage members 11, with an annular accommodating groove 12 formed between the resilient engage members 11 and the engage ring 1. Each resilient engage member 11 is formed with an outward arcuate protruding portion 13, and the engage ring 1 is bored with plural lateral insert holes 14. Besides, the steel ring 2 is urged in the accommodating groove 12 of the engage ring 1 to push outward the resilient engage members 11.

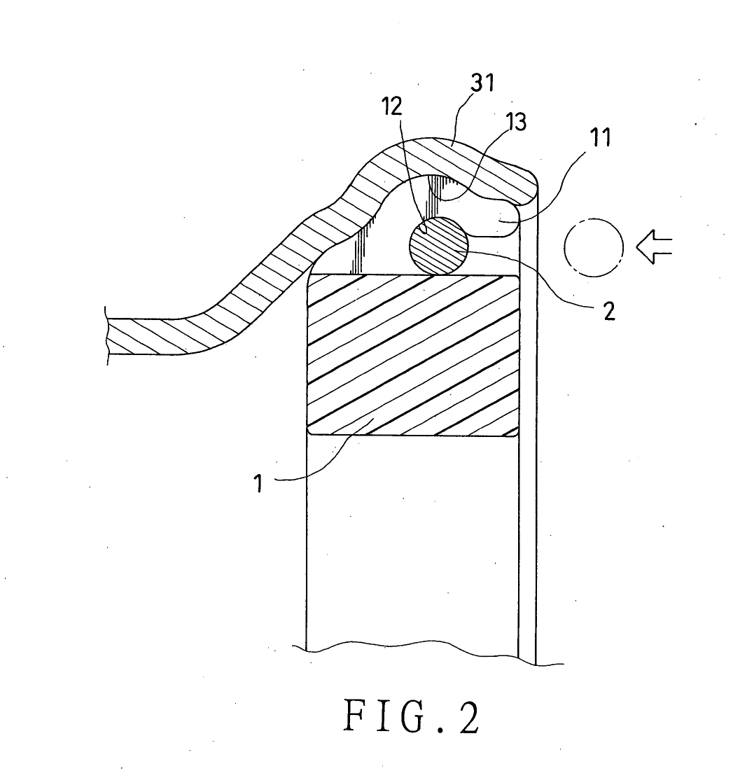

In assembling, as shown in FIG. 2, the engage ring 1 is first positioned in the recess of the flange 31 of a wheel rim 3 and then the steel ring 2 is forcefully fitted in the annular accommodating groove 12 of the engage ring 1 to force the resilient engage members 11 to expand outward and let the arcuate protruding portion 13 closely push against the inner side of the flange 31 and the engage ring 1 firmly fixed in the recess of the flange 31 of the wheel rim 3.

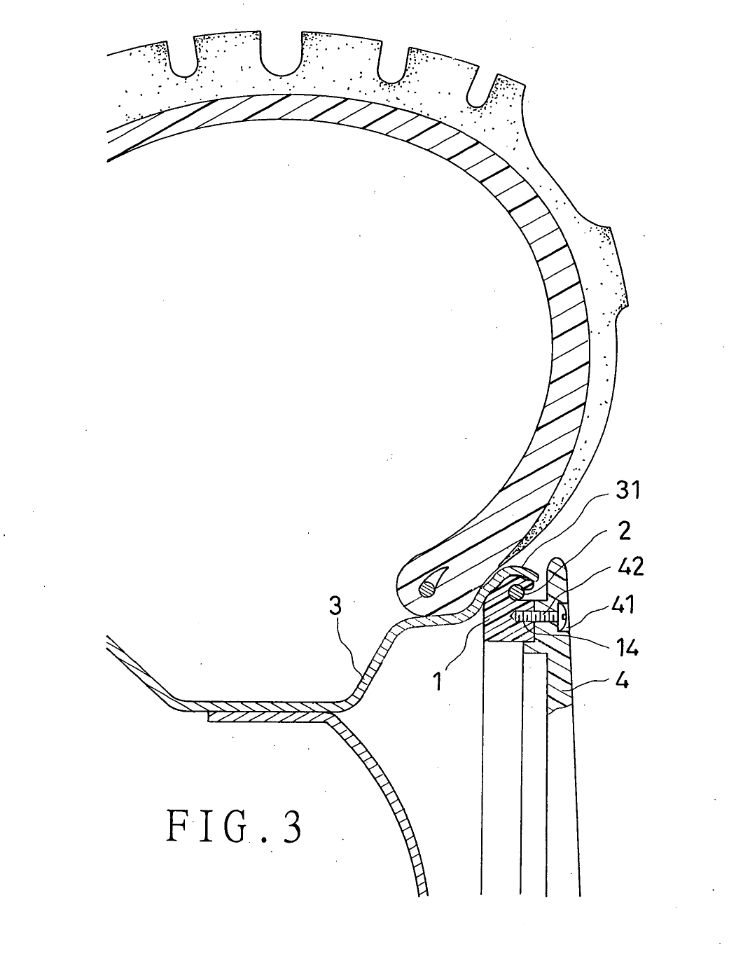

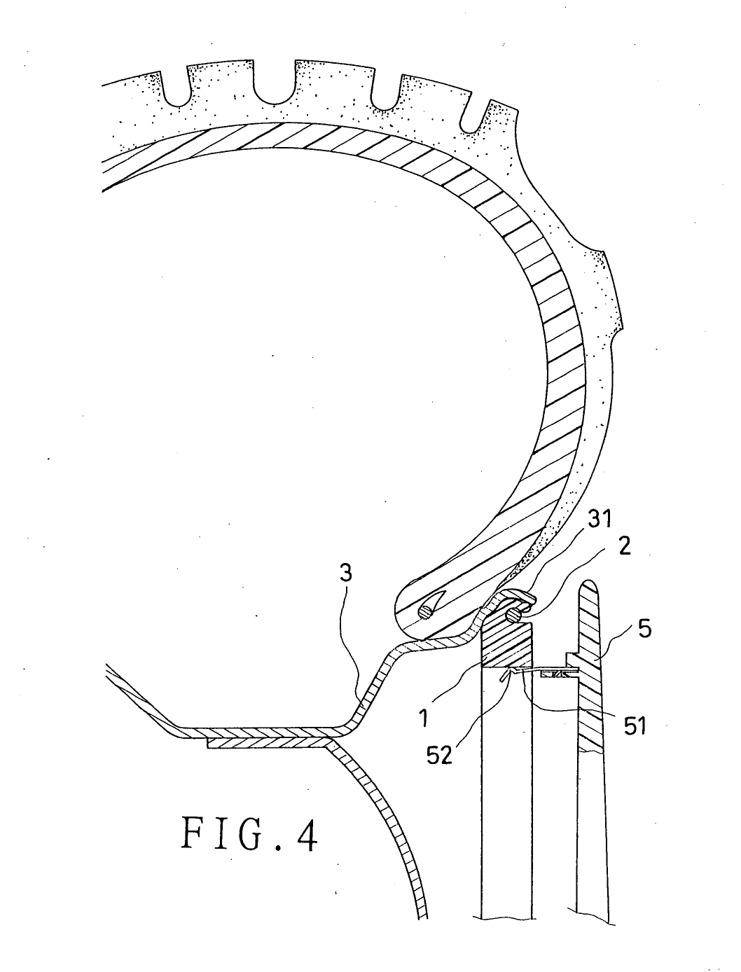

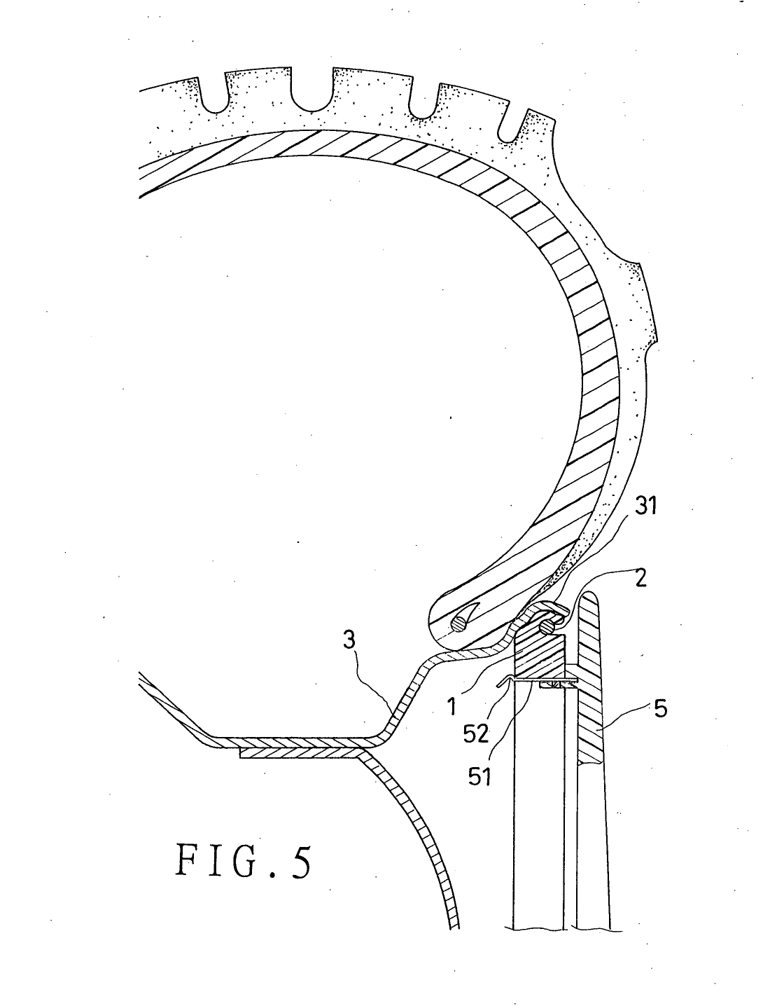

Subsequently, the wheel rim cover 4 is positioned on the outer side of the engage ring 1, letting the insert holes 41 of the wheel rim cover 4 respectively aligned to the insert holes 14 of the engage ring 1. Then, a screw 42 is screwed in the two insert holes 41, 14 to fix the wheel rim cover 4 on the wheel rim 3, as shown in FIG. 3. A second preferred embodiment of a wheel rim cover 5 is to have its inner side provided with plural fastening members 51 respectively having a hooking portion 52 formed at the outer end. The hooking portions 52 of the fastening members 51 of the wheel rim cover 5 firmly clasp the inner side of the engage ring 1 and fix the wheel rim cover 5 on the wheel rim 3, as shown in FIGS. 4 and 5.

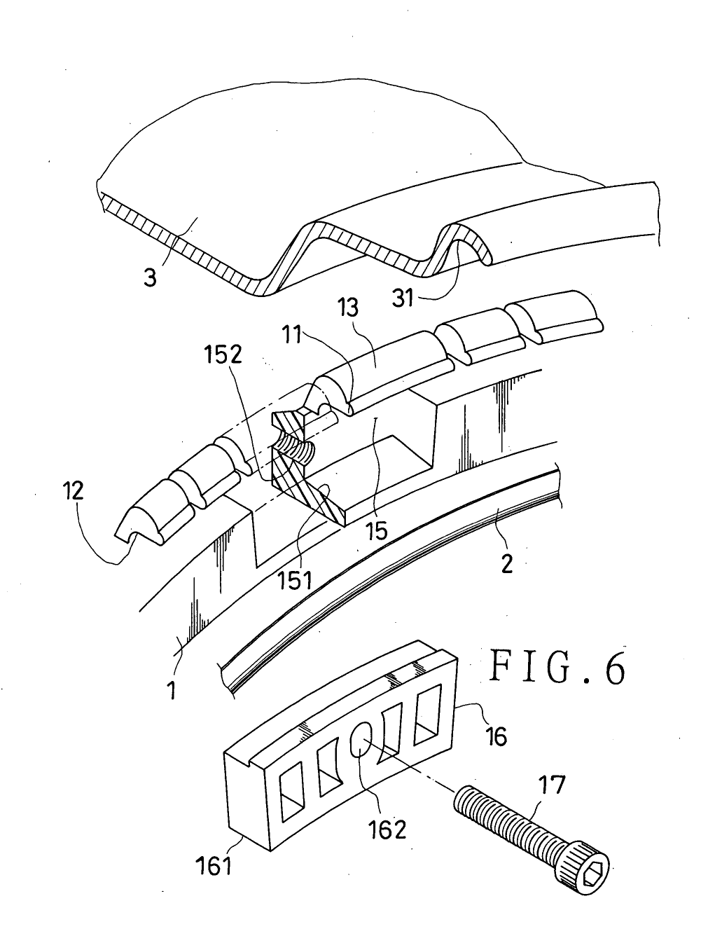

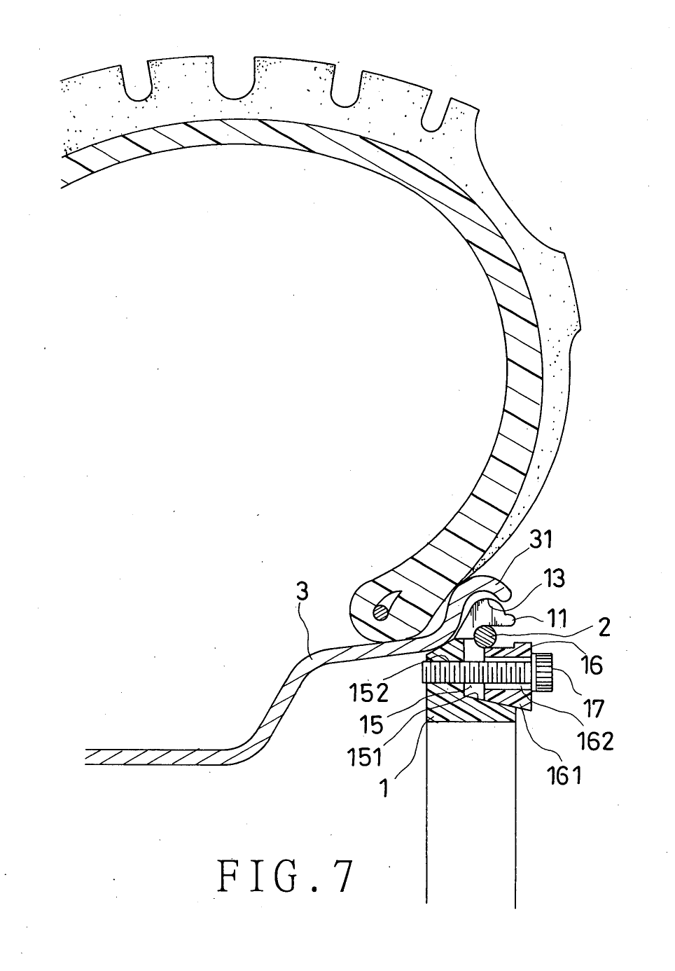

A third preferred embodiment of the wheel rim cover engagement device in the present invention, as shown in FIGS. 6 and 7, is to have the annular accommodating groove 12 of the engage ring 1 bored in the inner side with plural recessed grooves 15 respectively having a slope 151 on one side and a threaded hole 152 at the bottom. Plural push blocks 16 corresponding to the recessed grooves 15 of the engage ring 1 are respectively formed on one side with a slope 161 matching with the slope 151 of the recessed groove 15 of the engage ring 1 and bored with a lateral slot 162. A bolt 17 is inserted through the slot 162 of the push block 16 and screwed in the threaded hole 152 of the recessed groove 15 of the engage ring 1, letting the slope 151 of the recessed groove 15 and the slope 161 of the push block 16 fit with each other. Thus, when the screw 17 is gradually screwed inward, the push block 16 will be moved outward increasingly and push the steel ring 2 in the annular accommodating groove 12 to expand outward together with the resilient engage members 11, which enable the engage ring 1 to be firmly secured in the recess of the flange 31 of the wheel rim 3.

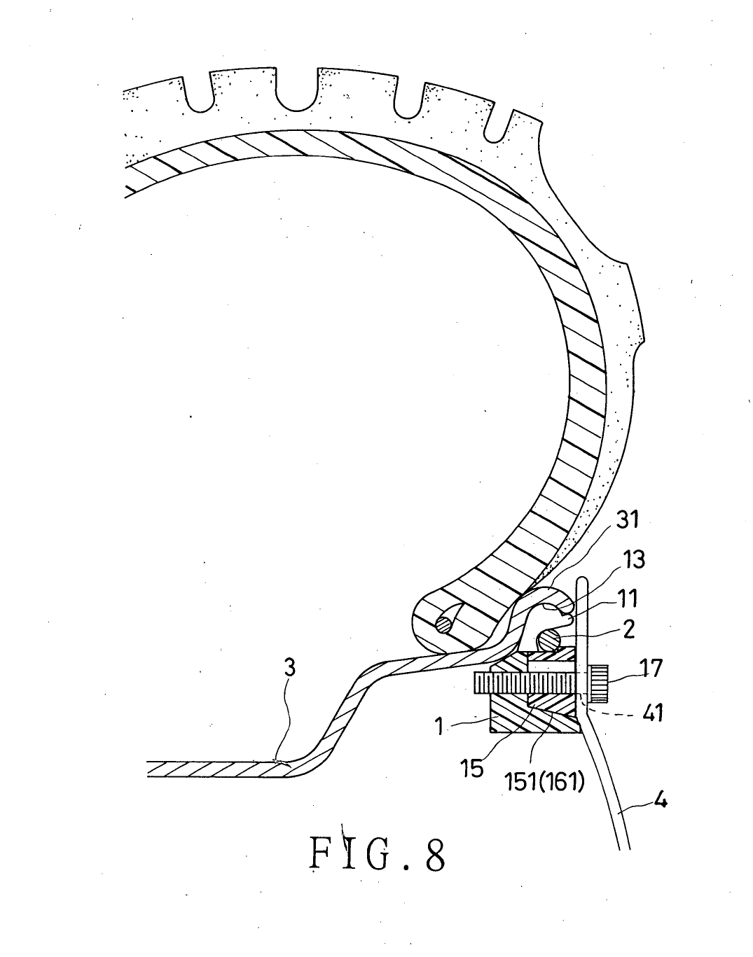

In addition, the screw 17 can also be inserted through the insert hole 41 of the wheel rim cover 4 and the slot 162 of the push block 16 and then screwed in the threaded hole 152 of the recessed groove 15 of the engage ring 1 to fix the wheel rim cover 4 on the wheel rim 3, as shown in FIG. 8.

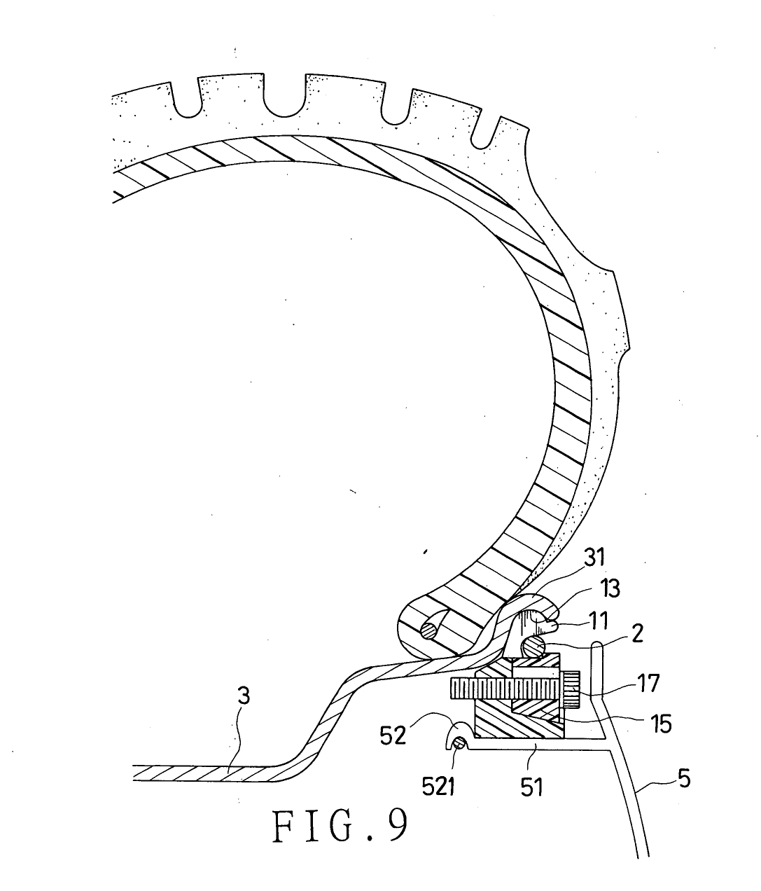

A fourth preferred embodiment of a wheel rim cover engagement device in the present invention, as shown in FIG. 9, is to have the hooking portions 52 of the fastening members 51 of the wheel rim cover 5 clasp the engage ring 1, and a steel ring 521 is firmly fitted with the hooking portions 52 to force the hooking portions 52 to move outward and stably clasp the engage ring 1, equally able to stably fix the wheel rim cover 5 on the wheel rim 3.

As can be noted from the above description, this invention has the following advantages, compared with the conventional wheel rim cover engagement device.

1. Different from the conventional wheel rim cover engagement device in which the locking blocks have to be adjusted to proper positions prior to assembly of a wheel rim cover, the engage ring of the wheel rim cover engagement device in the present invention is an annular body, so a wheel rim cover can be installed on a wheel rim at any angle.

2. The engage ring of this invention can easily be positioned in the recess of the flange of a wheel rim by means of its resilient engage members, and a steel ring is urged in the annular accommodating groove of the engage ring to force the resilient engage members to expand outward and let their arcuate protruding portions closely push against the inner wall of the flange of the wheel rim, easy and quick in assembling.

3. A wheel rim cover can be assembled on a wheel rim by means of its inner fastening members clasping the engage ring, needless to bore holes in a wheel rim cover and able to maintain its integral aesthetic appearance.

While the preferred embodiments of the invention have been described above, it will be recognized and understood that various modifications may be made therein and the appended claims are intended to cover all such modifications that may fall within the spirit and scope of the invention.

1. A wheel rim cover engagement device comprising an engage ring and a steel ring, said engage ring having its outer circumferential edge formed with a plurality of resilient engage members, an annular accommodating groove formed between said resilient engage members and said engage ring, each said resilient engage member having its outer end formed with an arcuate protruding portion, said steel ring urged in said accommodating groove to force said resilient engage members together with said arcuate protruding portions to expand outward and engage firmly in the inner recess of the flange of a wheel rim, said engage ring hence fixed stably with said wheel rim and a wheel rim cover able to be firmly assembled on said wheel rim by means of said engage ring.

2. A wheel rim cover engagement device comprising an engage ring and a steel ring, said engage ring having its outer circumferential edge formed with a plurality of resilient engage members, an annular accommodating groove formed between said resilient engage members and said engage ring, each said resilient engage member having its outer end formed with an arcuate protruding portion, said accommodating groove provided with plural recessed grooves in the inner side respectively for receiving a push block, said recessed groove and said push block respectively having a slope formed on the corresponding side, said push block bored with a slot and said recessed groove bored with a threaded hole, said slot and said threaded hole aligned to each other, a screw inserted through said slot and screwed in said threaded hole, by action of said two slopes, said steel ring in said accommodating groove pushed outward by said push block to make said engage ring and said wheel rim engage each other closely when said push block is moved outward, said resilient engage members together with said arcuate protruding portions pushed by said steel ring to expand outward and engaged firmly in the inner recess of said flange of said wheel rim, said engage ring thus fixed with said wheel rim, facilitating said wheel rim cover to be firmly assembled on said wheel rim by means of said engage ring.

3. The wheel rim cover engagement device as claimed in claim 1, wherein said engage ring is bored with plural insert holes, and screws are respectively inserted through the insert holes of said wheel rim cover and screwed in said insert holes of said engage ring to fix said wheel rim cover on the outer side of said engage ring.

4. The wheel rim cover engagement device as claimed in claim 2, wherein screws are respectively inserted through said insert holes of said wheel rim cover and said slots of said push blocks and then screwed in said threaded holes of said recessed groove of said engage ring to fix said wheel rim cover on the outer side of said engage ring.

5. The wheel rim cover engagement device as claimed in claim 1, wherein said wheel rim cover has the hooking portions of its inner fastening members clasp the inner side of said engage ring, equally able to fixedly assemble said wheel rim cover on said engage ring.

6. The wheel rim cover engagement device as claimed in claim 2, wherein said wheel rim cover has said hooking portions of said inner fastening members clasp the inner side of said engage ring and is stably assembled on said engage ring.

7. The wheel rim cover engagement device as claimed in claim 1, wherein said wheel rim cover has said hooking portions of said inner fastening members clasp the inner side of said engage ring, and a steel ring is fixedly fitted with said hooking portions to combine said wheel rim cover with said engage ring comparatively stably.

8. The wheel rim cover engagement device as claimed in claim 2, wherein said wheel rim cover has said hooking portions of said inner fastening members clasp the inner side of said engage ring and said steel ring is fixedly fitted with said hooking portions to combine said wheel rim cover with said engage ring comparatively stably.
